(19) United States
(12) Patent Application Publication
(10) Pub. No.: US 2015/0258535 A1
(43) Pub. Date: Sep. 17, 2015

(54) PRODUCTION OF CATALYSTS BASED ON BORON ZEOLITES

(71) Applicants: Asli Nau, Haltern am See (DE); Horst-Werner Zanthoff, Muelheim a.d. Ruhr (DE); Frank Geilen, Haltern am See (DE); Thomas Quandt, Marl (DE); Dietrich Maschmeyer, Recklinghausen (DE); Markus Winterberg, Waltrop (DE); Stephan Peitz, Oer-Erkenschwick (DE); Reiner Bukohl, Marl (DE); Christian Boeing, Shanghai (CN)

(72) Inventors: Asli Nau, Haltern am See (DE); Horst-Werner Zanthoff, Muelheim a.d. Ruhr (DE); Frank Geilen, Haltern am See (DE); Thomas Quandt, Marl (DE); Dietrich Maschmeyer, Recklinghausen (DE); Markus Winterberg, Waltrop (DE); Stephan Peitz, Oer-Erkenschwick (DE); Reiner Bukohl, Marl (DE); Christian Boeing, Shanghai (CN)

(73) Assignees: Evonik Degussa GmbH, Essen (DE); Evonik Industries AG, Essen (DE)

(21) Appl. No.: 14/432,928

(22) PCT Filed: Sep. 24, 2013
(86) PCT No.: PCT/EP2013/069824

§ 371 Date: Apr. 1, 2015

(30) Foreign Application Priority Data
Oct. 1, 2012 (DE) 10 2012 217 923.2

(51) Int. Cl. B01J 29/86; B01J 37/00; B01J 37/08; B01J 37/04; B01J 37/06

(52) U.S. Cl. CPC B01J 29/86; B01J 37/04; B01J 37/06; B01J 37/08; B01J 37/009

(57) ABSTRACT

The process described here has made it possible to obtain boron-containing silicates having a zeolitic structure which display negligible DME and C₈ selectivities combined with high activities when used as catalysts for the dissociation of MTBE.

The present invention relates to a process for producing catalysts based on boron-containing silicates having a zeolitic structure and also catalysts which can be obtained by the process.

Isobutene is a valuable starting material for producing many organic compounds in the chemical industry. It is used for producing butyl rubbers in the tyre industry and for obtaining polyisobutene, an intermediate for, inter alia, lubricant additives and fuel additives and also for adhesives and sealants. In addition, isobutene is used as alkylating agent, in particular for the synthesis of tertiary butylaromatics and as intermediate for the production of peroxides. In addition, isobutene can be used as precursor for methacrylic acid and esters thereof. An example which may be mentioned here is methyl methacrylate which is used for producing Plexiglas®. Further products produced from isobutene are branched C₅-aldehydes, C₅-carboxylic acids, C₅-alcohols and C₅-olefins. Isobutene therefore represents a product with high added value and an increasing demand on the world market. The chemical purity of the isobutene is critical for many applications; here, purities of up to 99.9% are required.

The raw material isobutene is obtained in the light naphtha fraction, the C₄-fractions from FCC units or from steam crackers of refiners and is thus present in admixture with other alkenes and saturated hydrocarbons having the same number of carbon atoms. In the work-up of the C₄ fraction, the butadiene, which makes up about 50% of the C₄ fraction, is separated off by extractive rectification or by selective hydrogenation to linear butenes in a first stage. The remaining mixture, known as Raffinat 1, comprises up to 50% of isobutene. Owing to the virtually identical physical properties of isobutene and 1-butene, economical isolation of the isobutene by distillation or extraction processes is not possible.

An alternative to the physical separation processes is derivatization of the isobutene, since it has a higher reactivity than the remaining C₄ components. A prerequisite is that the derivatives are easy to separate off from the Raffinat 1 and can subsequently be dissociated again into the desired product isobutene and the derivatizing agent. Important processes here are the reactions with water to form tert-butanol and with methanol to form methyl tert-butyl ether (MTBE). In the Hüls process, the MTBE synthesis is carried out in the liquid phase in the presence of acid catalysts at temperatures below 100° C. Ion exchangers such as sulphonated copolymers of styrene and divinylbenzene are used here as heterogeneous catalyst. Subsequent to the synthesis, MTBE can easily be separated off from the C₄ fraction by distillation in a next process step because of the large differences in the boiling points and can subsequently be redissociated selectively into the products isobutene and methanol. The coproduct methanol can be recirculated back to the MTBE synthesis. Existing plants for C₄ work-up and for the synthesis of MTBE can thus be extended by the process step of MTBE dissociation.

The dissociation of MTBE is an endothermic equilibrium reaction. The thermodynamic equilibrium thus shifts in the direction of the dissociation products with increasing temperature. An increase in the pressure brings about a shift in the chemical equilibrium in the direction of the starting material MTBE. The dissociation of MTBE can be carried out either homogeneously in the liquid phase or in the gas phase in the presence of heterogeneous catalysts. Owing to the low stability of homogeneous catalysts and the lower equilibrium conversions in the liquid phase, the gas-phase dissociation of MTBE over solid-state catalysts is preferred. In a gas-phase reaction at atmospheric pressure, an equilibrium conversion of about 95% is achieved at above 160° C.

In industrial preparation, an absolute pressure of 7 bar, i.e. above the vapour pressures of the components to be expected in the reaction medium, is desirable in order to save costs for the compression of the gases in downstream processing and at the same time to be able to achieve condensation by means of cooling water. The dissociation of MTBE takes place in the presence of an acid catalyst. In the literature, the usability of amorphous and crystalline aluminosilicates and of metal sulphates on silicon or aluminium, supported phosphoric acid and of ion-exchange resins is reported. However, the precise mechanism of the acid-catalyzed dissociation of MTBE has hitherto not been indicated in the literature.

Owing to the high reaction temperatures of the heterogeneously catalyzed gas-phase dissociation, some undesirable by-products are formed in addition to isobutene and methanol. The dehydrogenation of methanol leads to the undesirable subsequent product dimethyl ether (DME). Isobutene dimerizes to form the oligomers 2,4,4-trimethyl-1-pentene (TMP-1) and 2,4,4-trimethyl-2-pentene (TMP-2). Depending on the catalyst system, further oligomerization reactions such as the formation of trimers cannot be ruled out. In addition, the equilibrium reaction of isobutene with water to form tert-butanol (TBA) is to be expected. Furthermore, direct reaction of MTBE with water to form TBA and methanol cannot be ruled out.

Owing to the demanding requirements in respect of the purity of isobutene for downstream uses, the formation of the abovementioned undesirable by-products has to be suppressed as far as possible. The focus here is mainly to minimize the subsequent reaction of isobutene to form oligomers and the dehydrogenation of methanol to form DME, since by-product formation firstly incurs the costs of purification and secondly reduces the yield of the products isobutene and methanol. The catalyst used for the dissociation of MTBE plays a critical role in formation of the undesirable components.

Many catalysts having acidic properties have been described in the literature for the gas-phase dissociation of ethers. A number of patents claim sulphonic acids as catalysts for ether dissociation and guarantee selectivities in respect of the main components isobutene and methanol of up to 89.3% or 97.8% at conversions of up to 55%. However, it is found that the use of strongly acidic catalysts such as sulphonic acids and phosphoric acids leads to a decrease in the isobutene selectivities.

Amorphous and crystalline aluminosilicates and also modified aluminosilicates are the subject matter of numerous publications. When aluminosilicates are used, reaction temperatures of from 150 to 300° C. and pressures of from 1 to 7 bar are usually employed. Many patents claim amorphous or even crystalline aluminosilicates which have a proportion of from 0.1 to 80% of aluminium and achieve selectivities in respect of isobutene and methanol of up to 99.8% and 99.2%, respectively, at conversions of 98%.

In addition, metal oxides of elements of intermediate electronegativity, e.g. magnesium, titanium, vanadium, chromium, iron, cobalt, manganese, nickel, zirconium and boron, have been described in addition to the aluminosilicates for ether dissociation. Furthermore, the aluminosilicates can be doped with the abovementioned metal oxides in order to influence the acidity of the catalyst.

It is clear that all catalyst systems display high activities 70%) in respect of the dissociation of MTBE. When the selectivities to isobutene and methanol are compared, differences are found among the materials. Here, no direct relationship with the composition, additional doping or nature of the surface of the solids is found.

Zeolites are hydrated crystalline aluminosilicates having a three-dimensional anion framework made up of [SiO₄] and [AlO₄] tetrahedra which are joined via oxygen atoms. The zeolite framework usually forms a highly ordered crystal structure having channels and voids. Cations which can be exchanged or reversibly removed serve to compensate the anionic framework charge. The chemical composition of the unit cell is indicated by the following general formula:

M_{x/n}[(AlO₂)ₓ(SiO₂)_{y}]·wH₂O

where n is the valancy of the cation M and w is the number of water molecules per unit cell. The Si/Al ratio is such that y/x≧1. The isomorphous replacement of aluminium or silicon by other network-forming elements leads to widely varying zeolite-analogous materials. Taking into account the substitution possibilities, the following formula is obtained for zeolites and zeolite-analogous materials:

Mₓ·M′_{y}N₂·[Tₘ·T′ₙ·O_{2(m+. . . -a)}·(OH)₂ₐ]·(OH)_{br}·(aq)ₚ·qY

T=Al, B, Be, Ga, P, Si, Ti, V, etc

M and M′ are exchangeable or nonexchangeable cations, N represents non-metallic cations, (aq)ₚ is strongly bound water, qY represents sorbate molecules which also include water and (OH)₂ₐ represents hydroxyl groups at network fracture points. If charge equalization occurs by means of protons, the zeolites are proton-exchanged zeolites which, depending on the zeolite properties, have weak to strong acidities. This property and the defined pore system having a large specific surface area (several 100 m²/g) predestine zeolites as catalysts for acid-catalyzed, shape-selective, heterogeneous reactions. The dimensions of these pore openings, which are in the order of molecule diameters, make the zeolites particularly suitable as selective adsorbents, for which reason the expression “molecular sieves” has become established.

A nomenclature based on the topology of the host framework has been proposed for natural zeolites and zeolite-like substances by the IZA in “Atlas of Zeolite Structure Types” and this has been approved by the IUPAC. Accordingly, most synthetic zeolites are named by the combination of a three-letter structure code. Examples which may be mentioned are the structure types SOD (sodalite), LTA (zeolite A), MFI (pentasil zeolite), FAU (zeolite X, zeolite Y, faujasite), BEA (zeolite beta) and MOR (mordenite).

Zeolites of the MFI structure type are “medium-pored” zeolites. An advantage of this structure type is their uniform channel structure compared to the “narrow-pored” structure types (SOD, LTA) and “wide-pored” structure types (FAU, BEA, MOR). The MFI structure type belongs to the group of crystalline, microporous aluminosilicates and is an extraordinarily shape-selective and thermally stable but also highly acidic zeolite. However, the use of strongly acidic zeolites as catalysts for the dissociation of MTBE can, as indicated above, lead to a deterioration in the isobutene selectivities.

There are a few pointers in the prior art to the use of boron zeolites as catalyst in the dissociation of MTBE:

Thus, DE2953858C2 describes the use of “boralites” as catalysts in the dissociation of MTBE. These boralites are double oxides of silicon and boron which have a porous crystalline structure and represent boron-modified silicas and have a zeolitic structure. There is no information on the structure type of these boralites. They are prepared under hydrothermal conditions at a pH of from 9 to 14.

EP0284677A1 discloses a process for producing a catalyst for the cracking of nitrogen-containing oil such as shale oil, which is based on a boron-containing crystalline material having a zeolitic structure. ZSM-5, ZSM-11, ZSM-12, beta and Nu-1 are mentioned as possible zeolite structures. The preparation is carried out in a basic medium. The suitability of these catalysts for the dissociation of MTBE is not indicated.

In the light of this prior art, it is an object of the present invention to provide novel catalysts which are not only shape-selective and thermally stable but, also have an acidity which can be set in a controlled manner, so that they are highly suitable for the dissociation of MTBE, i.e. not only ensure highly active dissociation of MTBE but at the same time ensure high selectivities to the main products isobutene and methanol.

The object is achieved according to the invention by a process for producing catalysts based on boron silicates having a zeolitic structure according to claim 1 and by catalysts which can be obtained by this process.

Silicates are the salts and esters of orthosilicic acid Si(OH)₄ and condensation products thereof. For the purposes of the present invention, a “boron-containing silicate” (“boron silicate” for short) is a silicate which contains boron in oxidic form. The term “zeolitic structure” means a morphology corresponding to the zeolites. The term “zeolite-analogous” is used synonymously. According to the conventional definition, zeolites belong to the group of aluminosilicates, i.e. silicates which contain aluminium in oxidic form. Since the boron silicates described here correspond in terms of their morphology to zeolites, they will hereinafter also be referred to as “boron zeolites” for short. However, the use of the term “boron zeolite” does not mean that this material necessarily has to contain aluminium. Boron zeolites according to the invention are even preferably free of aluminium, apart from impurities or trace constituents.

The boron zeolites which have been modified by the process of the invention have been found to be active and selective catalysts for the dissociation of MTBE into isobutene and methanol. The result is catalysts which display a conversion of up to 90% at negligible degrees of oligomerization (up to 0.0025% C₈ selectivity) and the lowest DME selectivities yet observed (down to 0.2%).

The present invention therefore provides a process for producing catalysts based on boron silicates, which comprises the following steps:
a) provision of an aqueous suspension containing at least one boron-containing silicate having a zeolitic structure,
b) addition of acid to set a pH in the range from 1 to 5,
c) stirring of the suspension,
d) isolation of the solid obtained,
e) optionally washing of the solid,
f) calcination of the solid.

In the process of the invention, particular preference is given to using boron zeolites of the MFI structure type since they are accompanied by many advantages. It is known that the acidity of a zeolite can be influenced as follows by incorporation of heteroatoms into the silicon framework:

acid strength: B<<Fe<Ga<Al

Accordingly, a boron-containing zeolite is a much less acidic zeolite than a zeolite containing only aluminium and silicon. This is not as expected since boron has a higher electronegativity than aluminium.

The process of the invention enables the Si/B ratio to be varied over a wide range and thus offers many opportunities of adjusting the catalytic properties. In addition, zeolites of the MFI structure type have a uniform channel structure and are therefore extraordinarily shape-selective and thermally stable. Zeolites of this structure type are particularly resistant to carbonization, presumably due to the small dimensions.

In the process of the invention, the at least one zeolite in step a) advantageously has a molar ratio of SiO₂/B₂O₃ in the range from 2 to 4, preferably from 2.3 to 3.7, particularly preferably 3.

As indicated above, the boron zeolite according to the invention is not a zeolite in the strict sense since it does not contain any aluminium. It is preferably free of aluminium or contains aluminium at most in the form of impurity or as trace constituent. An aluminium content below 0.1% by weight is tolerable.

However, it is critical that the boron content of the catalyst of the invention is below 1% by weight. A boron content which is too high could promote by-product formation. The boron content is preferably even below 0.5% by weight, very particularly preferably at 0.3% by weight. If the boron-containing silicate provided in the suspension has a proportion of boron which is too high, this can be reduced by the acid treatment. In comparison with Al, B can quite readily be washed out by means of acid. Acid treatment has enabled the boron content of an untreated silicate to be reduced from 1% by weight to about 0.1% by weight. Thus, the silicate present in the suspension should have a boron content in the range mentioned, at least after addition of the acid.

In terms of the catalytic properties, it is advantageous for the boron silicate in step a) to have a surface area measured by the BET method in the range from 300 m²/g to 500 m²/g, preferably from 330 to 470 m²/g, particularly preferably from 370 to 430 m²/g.

Among the numerous methods available in solid-state chemistry, the hydrothermal synthesis is a particularly suitable synthesis for the zeolites used in the process of the invention. In addition, further ways of synthesizing the zeolites are conceivable. The starting materials essential for the zeolite synthesis can be divided into the following four categories: source of the T atoms (boron source or silicon source), template, mineralizer and solvent.

Silicon sources which are frequently used in the synthesis of zeolites are silica gels, pyrogenic silicas, silica sols (colloidally dissolved SiO₂) and alkali metal metasilicates. Common boron sources are boric acid or alkali metal borates.

The template compounds have structure-directed properties and stabilize the zeolite structure during the synthesis. Templates are generally monovalent or polyvalent inorganic or organic cations. Apart from water, bases (NaOH), salts (NaCl) or acids (HF) are used as inorganic cations or anions. Organic compounds which come into question for zeolite syntheses are, in particular, alkyl ammonium or aryl ammonium hydroxides.

The mineralizer catalyzes the formation of transition states required for nucleation and crystal formation. This occurs via dissolution, precipitation or crystallization processes. In addition, the mineralizer increases the solubility and thus the concentration of the components in the solution. As mineralizer, it is possible to use hydroxide ions by means of which the ideal pH for the zeolite synthesis can be set. As the OH concentration increases, there is a decrease in the condensation of the silicon species while the condensation of the aluminium anions remains constant. Thus, the formation of aluminium-rich zeolites is aided by high pH values; silicon-rich zeolites are preferentially formed at relatively low pH values. In the case of largely aluminium-free boron silicates, pH values of from 9 to 11 lead to low boron contents of less than 1% by weight. The solvent used in many cases in the zeolite synthesis is water.

To synthesize the zeolites, the reactive T atom sources, the mineralizer, the template and the water are mixed to form a suspension. The molar composition of the synthesis gel is the most important factor for influencing the reaction products:

SiO₂:aB₂O₃:bAl₂O₃:cMₓO:dN_{y}O:eR

M and N are alkali metal or alkaline earth metal ions and R is an organic template. Furthermore, the coefficients a to e indicate the molar ratios based on one mole of silicon dioxide.

The coefficients preferably have the following values:
a=0.000001 to 0.2
b<0.006
c<1
d<1
0<e<1

The suspension is transferred to an autoclave and subjected to alkaline conditions, autogenous pressure and temperatures of from 100 to 250° C. for from a few hours to a number of weeks. Under hydrothermal conditions, the synthesis solution becomes supersaturated, which initiates nucleation and the subsequent crystal growth. Apart from nucleation, the crystallization temperature and time are critical to the outcome of the zeolite synthesis. Since crystallization is a dynamic process, crystals which have been formed are redissolved and converted. According to Ostwald's rule of stages, the most energy-rich species are formed first, and the formation of lower-energy species then occurs stepwise. The crystallization time also depends, inter alia, on the zeolite structure. In the case of zeolites of the MFI structure type, experience has shown that the crystallization is concluded after 36 hours.

After the hydrothermal synthesis, the template is removed by calcination in a stream of air at from 400 to 600° C. Here, the organics are burnt to form carbon dioxide, water and nitrogen oxides.

To modify the boron silicate, an acid treatment is carried out in step b), resulting in a reduction in the boron content. This leads to an increase in the activity of the zeolites or to selective production of desired active sites. In addition, an additional stabilization of the framework is observed.

For the acid treatment, it is possible to employ hydrochloric acid, phosphoric acid, sulphuric acid, acetic acid, nitric acid and oxalic acid. The degree to which the boron content is reduced here depends, in particular, on the acid used, its concentration and the temperature of the treatment. In the context of the present invention, it has been found that hydrochloric acid and phosphoric acid extract boron even at low concentrations, in contrast to sulphuric acid and nitric acid. In a preferred embodiment of the invention, the setting of the pH in step b) is therefore effected by addition of hydrochloric acid or phosphoric acid.

Furthermore, it has been found, in the context of the present invention, that stirring of the suspension in step c) is advantageously carried out at not more than 80° C. Preferred embodiments of the present invention therefore provide for the stirring of the suspension in step c) to be carried out at not more than 80° C. However, the maximum stirring temperature depends on the acid used. While HCl requires a temperature of 80° C., in the case of H₃PO₄ good results were achieved at as low as 25° C. When phosphoric acid is used, the maximum stirring temperature should therefore be 25° C. The stirring temperature should if possible not be below 0° C. since freezing water makes stirring difficult.

The duration of stirring is at least 6 hours, preferably at least 12 hours, particularly preferably at least 24 hours. In practice, stirring times can be up to about 36 hours.

The isolation of the solid in step d) can be carried out by any desired method. Depending on the particle size, vacuum filtration and superatmospheric pressure filtration are possibilities.

To purify the solid, it can be washed with water, optionally repeatedly, in a further step.

It is possible for defects generated in the framework to be healed at high calcination temperatures by silanol condensation to form a cristobalite. In the process of the invention, the calcination of the solid in step f) is preferably carried out at a temperature of not more than 500° C., particularly preferably not more than 400° C., in particular not more than 350° C.

The calcination of the solid can in principle be carried out in a stream of air. An embodiment of the present invention therefore provides for the calcination of the solid in step f) to be carried out in a stream of air.

The healing of the defects generated in the framework at high calcination temperatures by silanol condensation can also be avoided by ensuring the absence of water or oxygen during the calcination operation by introduction of an inert gas such as nitrogen.

In an embodiment of the present invention, the calcination of the solid in step f) is therefore carried out in a stream of pure nitrogen.

Since both air and nitrogen are suitable as calcination atmosphere, it can generally be presumed that the calcination can advantageously be carried out in any nitrogen-containing atmosphere. An embodiment of the invention therefore provides for calcination in a nitrogen-containing atmosphere. A “nitrogen-containing atmosphere” is a gas or gas mixture which contains nitrogen in molecular form. The calcination can therefore be carried out in the presence of molecular nitrogen gas (N₂) or in the presence of a gas which contains nitrogen together with further types of molecules, for example hydrogen (H₂).

To remove the excess acid, the solid obtained can, after cooling to room temperature, be washed with distilled water, optionally repeatedly. Finally, the calcination in the stream of nitrogen or air is repeated.

A preferred embodiment of the invention thus comprises the above-described process in which the solid obtained in step f) is washed with water and step f) is subsequently repeated.

After the calcination, the solid obtained can be treated with methanol. In this case, the solid is dipped into static methanol or flowing methanol is passed over the solid. The methanol can in both cases be liquid, gaseous or mixed liquid/gaseous. Treatment of the solid with methanol brings about a reduction in the initial activity of the catalyst, which has been found to be advantageous in industrial use. The methanol treatment of the catalyst based on boron silicate is carried out in a manner analogous to the methanol treatment of aluminosilicate-based catalysts, which is described in the German patent application DE102012215956 which was still unpublished at the point in time of the present patent application. The content of this patent application is thus expressly incorporated by reference. Instead of methanol, the solid can also be treated with any other preferably monohydric alcohol such as ethanol.

In a particularly preferred embodiment of the invention, the boron silicate which is free of aluminium apart from impurities or trace constituents in step a) has a molar ratio of SiO₂/B₂O₃ of about 3, a boron content below 0.5% by weight and a surface area measured by the BET method of about 405 m²/g, the setting of the pH in step b) is effected by addition of phosphoric acid or hydrochloric acid, the stirring of the suspension in step c) is carried out at from 20 to 80° C. for a period of at least 24 hours and the isolation of the solid in step d) is carried out by vacuum filtration or superatmospheric pressure filtration, the solid is washed with water in step e) and the calcination of the solid in step f) is carried out at a temperature of not more than 350° C. in a stream of nitrogen or in a stream of air.

The boron zeolites which have been modified by the process of the invention have low selectivities in respect of DME and C₈ at a conversion of 90% when used as catalysts in the dissociation of MTBE and therefore have great potential for industrial use in the dissociation of MTBE.

The present invention thus also provides a catalyst comprising a boron-containing silicate which has a zeolitic structure of the MFI type and can be obtained by a production process as described above.

Particularly low selectivities in respect of DME and C₈ at a conversion of 90% are achieved when the proportion of boron in the zeolites which can be obtained by the above-described process according to the invention is less than 1% by weight. The boron content is particularly preferably even below 0.5% by weight.

The process of the invention has made it possible to obtain boron-containing silicates having a zeolitic structure which display negligible DME and C₈ selectivities combined with high activities when used as catalysts for the dissociation of MTBE.

The following examples illustrate the present invention.

### EXAMPLES

### Production of the Boron-Containing Zeolites of the MFI Structure Type to be Used for the Process of the Invention

Variant 1)

90 g of TPAOH (tetrapropylammonium hydroxide), 117 g of SiO₂ in the form of colloidal silicon (LUDOX AS 40 from Sigma Aldrich), 10 g of H₃BO₃ (boric acid) and 901 g of distilled water are processed in a glass beaker to form a suspension. The made-up solution is stirred for a further 5 hours. During this time, a pH in the range from 9.3 to 9.6 is established. The synthesis solution is subsequently transferred to a double-walled stirred reactor from Büchi® with PTFE coating and stirred under autogenous pressure at 185° C. for 24 hours. After the hydrothermal synthesis, the solid in the suspension is isolated by means of vacuum filtration. The filter cake which remains is repeatedly washed with distilled water and subsequently calcined. Calcination of the solid is carried out in a stream of nitrogen (200 ml/min) in a muffle furnace. The heating rate is 1° C./min, and the final temperature of 500° C. is maintained for 5 hours.

Variant 2)

79 g of TPABr (tetrapropylammonium bromide), 6 g of NaOH, 72 g of SiO₂ (LUDOX AS 30 from Sigma Aldrich), 4 g of H₃BO₃ and 524 g of distilled water are processed in a glass beaker to form a suspension. A pH of 12.57 is established. The synthesis solution is subsequently transferred to a stirred reactor and stirred under autogenous pressure at 165° C. for 24 hours. After the hydrothermal synthesis, the solid in the suspension is isolated by superatmospheric pressure filtration. The filter cake which remains is repeatedly washed with distilled water and subsequently calcined. Calcination of the solid is carried out in a stream of air (200 ml/min) in a muffle furnace. The heating rate is 1° C./min, and the final temperature of 450° C. is maintained for 8 hours. To effect ion exchange, 5 g of the fine powder is treated with a solution consisting of 0.1 molar NH₄Cl and 1 molar NH₄OH in three passes for 2 hours at room temperature. While stirring continually, a pH in the range from 10 to 11 is established. After ion exchange is complete, the solid is once again separated from the suspension by superatmospheric pressure filtration. The filter cake is subsequently subjected to diffusion washing with 1 molar NH₄OH. In a last step, the solid obtained is calcined in a stream of air (200 ml/min) in a muffle furnace (heating rate: 1° C./min; final temperature: 450° C.; duration: 8 hours).

### Production According to the Invention of Catalysts Based on Boron Zeolites

### Example 1

3 g of the solid produced by variant 2 are transferred together with 300 ml of distilled water into a double-walled glass vessel. 0.01 molar HCl is added so that, depending on the objective, pH values of from 1 to 5 can be set. The solution is stirred using a magnetic stirrer over the entire treatment time and maintained at from 20 to 80° C. by means of an attached thermostatic bath (heat-transfer oil: ethylene glycol). After 24 hours, the suspension is cooled to ambient temperature and, depending on the particle size, filtered by vacuum filtration or superatmospheric pressure filtration. The solid obtained therefrom is repeatedly washed with distilled water and, in a final step, calcined at 350° C. in a stream of air or nitrogen (200 ml/min) in a muffle furnace (heating rate: 7° C./min) for 5 hours.

### Example 2

3 g of the solid produced by variant 1 are transferred together with 300 ml of distilled water into a double-walled glass vessel. 85% strength H₃PO₄ is added so that, depending on the objective, pH values of from 1 to 5 can be set. The solution is stirred at room temperature using a magnetic stirrer over the entire treatment time. After 24 hours, the solid is, depending on the particle size, filtered by vacuum filtration or superatmospheric pressure filtration, washed with distilled water and calcined. Calcination is carried out at 350° C. in a stream of nitrogen or air (200 ml/min) in a muffle furnace (heating rate: 7° C./min). To remove excess H₃PO₄, the samples are, after cooling to room temperature, alternately washed with distilled water and filtered a number of times. Finally, the calcination at 350° C. (heating rate: 7° C./min) in a stream of nitrogen or air is repeated.

### Use of Catalysts Produced According to the Invention for the Dissociation of MTBE

The reaction components are fed under quantity or pressure regulation from separate reservoirs via a vaporizer to the catalyst beds. The analysis of the reaction products is carried out by means of on-line gas chromatography.

Conversions in the range from 10 to 100% are set by varying the reactor temperature in the range from 200 to 230° C. and the space velocity (WHSV) in the range from 0.005 to 5 h⁻¹.

The boron zeolite from Example 1 displays a high activity in respect of the dissociation of MTBE and low selectivities in respect of DME (0.2%) and C₈ (0.004%) at a conversion of 90%.

The boron zeolite from Example 2 displays a high activity in respect of the dissociation of MTBE and low selectivities in respect of DME (0.4%) and C₈ (0.015%) at a conversion of 90%.

1. A process for producing a catalyst based on boron-containing silicates having a zeolitic structure, which comprises:
a) providing an aqueous suspension containing at least one boron-containing silicate having a zeolitic structure,
b) adding acid to set a pH in the range from 1 to 5,
c) stirring the suspension,
d) isolating the solid obtained,
e) optionally, washing the solid,
f) calcining the solid.

2. The process according to claim 1, wherein the at least one boron-containing silicate has a zeolitic structure of an MFI type.

3. The process according to claim 1, wherein the silicate present in the suspension has a molar ratio of SiO₂/B₂O₃ in the range from 2 to 4.

4. The process according to claim 1, wherein the silicate present in the suspension has an aluminium content of less than 0.1% by weight.

5. The process according to claim 1, wherein the silicate present in the suspension has, at least after addition of the acid, a boron content of less than 1% by weight.

6. The process according to claim 1, wherein the silicate in step a) has a surface area measured by the BET method ranging from 300 m²/g to 500 m²/g.

7. The process according to claim 1, wherein the setting of the pH in step b) is effected by addition of hydrochloric acid.

8. The process according to claim 1, wherein the setting of the pH in step b) is effected by addition of phosphoric acid.

9. The process according to claim 1, wherein the stirring of the suspension in step c) is carried out at not more than 80° C.

10. The process according to claim 9, wherein the stirring of the suspension in step c) is carried out at not more than 25° C.

11. The process according to claim 1, wherein the stirring of the suspension in step c) is carried out for a period of at least 24 hours.

12. The process according to claim 1, wherein isolation of the solid in step d) is carried out by vacuum filtration or by superatmospheric pressure filtration.

13. The process according to claim 1, wherein the solid is washed with water in step e).

14. The process according to claim 1, wherein calcination of the solid in step f) is carried out at a temperature of not more than 500° C.

15. The process according to claim 1, wherein the calcination of the solid in step 0 is carried out in a nitrogen-containing atmosphere.

16. The process according to claim 1, wherein the solid obtained in step 0 is washed with water and step f) is subsequently repeated.

17. The process according to claim 1, wherein the calcined solid is treated with methanol.

18. A catalyst comprising a boron-containing silicate which has a zeolitic structure that can be obtained by a process according to claim 1.

19. The catalyst according to claim 18, wherein the zeolitic structure is of an MFI type.

20. The catalyst according to claim 18, which has a proportion of boron less than 1% by weight.
